(19) United States
(12) Patent Application Publication
(10) Pub. No.: US 2020/0247539 A1
(43) Pub. Date: Aug. 6, 2020

(54) VACUUM DEVICE FOR DRONE DELIVERY OF PACKAGES

(71) Applicant: Stephen P. Shoemaker, JR., Redondo Beach, CA (US)

(72) Inventor: Stephen P. Shoemaker, JR., Redondo Beach, CA (US)

(21) Appl. No.: 16/269,475

(22) Filed: Feb. 6, 2019

(51) Int. Cl. B64D 1/12; B64C 39/02

(52) U.S. Cl. CPC B64D 1/12; B64C 2201/146; B64C 2201/128; B64C 39/024

(57) ABSTRACT

A pilotless drone is equipped with a package for prompt delivery to a local destination, maybe an hour away. The drone includes a vacuum pump and a vacuum release mechanism to remotely release the package once the drone is positioned at the destination.

### BACKGROUND

Unmanned Aerial Vehicles (UAVs), or drones, are aircrafts that can be navigated without a human pilot on board the aerial vehicle. Drones can be navigated via control from the ground, using a GPS tracking system. Drones may be equipped with cameras that allow the user to record and take pictures using controlled navigation, and their current uses include hobbies and image capturing. Drones have grown in popularity in recent years, and new models have been released lately with newer and better features. Drones are navigated via their channel control and transmitter; the higher the channel control, the better the user can navigate the drone at a higher speed.

Delivery of packages by drone is not new. Many systems are being developed but depend on some mechanical grabbing mechanism to hold and release packages. However, there are inherent defects in the current drone delivery systems that can be obviated by the present invention.

### SUMMARY OF THE INVENTION

A delivery drone with a vacuum release system is new, has few to no moving parts, and is light weight, strong, reliable and simple. The benefit of a vacuum release system is that it can be released without any latching mechanism that can stick, jam, or fail. In a vacuum system, once the vacuum is turned off and the valve opens, the release is automatic. The pump/valve is wired in parallel so they operate together. the pump draws the vacuum and the valve allows the vacuum to dissipate when power is removed. There are other systems that may not require a valve. The vacuum cup lifts square, oblong, round, flat or irregular shaped containers equally and the only requirement is a smooth surface. Such deliveries can occur out in any location by human or digital control over land or water for person or business. Not only is time saved to get the item delivered, but reliability and simplicity of the system are unique to the effort. The present invention is directed to a system and method for delivering items using vacuum in a quick and effective manner.

Commercial drones are capable of carrying up to 20 kilograms of weight or more, and can be maneuvered quickly into an accurate position above an object using a camera or line of sight. The present invention takes advantage of these newer features of drones, by using a suction system to deliver packages. A service, for example, can deliver a package quickly, a doctor could deliver a heart to a nearby hospital saving lives or a company could deliver a hot dog in minutes. By getting items delivered quickly, more expediently, much time can be saved. The drone of the present invention is equipped with a radio-activated release mechanism for dropping the package from the drone once it has reached the destination. One preferred embodiment is a vacuum release mechanism where an electric vacuum pump and valve operating on the same voltage as the drone, or an independent power source, is coupled to a suction cup that retains the package suspended below the drone. A relay control switch is present that turns off the pump at a command of the user, eliminating the suction and releasing the item being delivered.

Other release mechanisms have inherent shortcomings. Metal or plastic clasps or grippers can jam, fail to release, or become stuck due to sand and other debris in the release mechanism. Magnets are unreliable and can prematurely release when subjected to wind or other forces. Using ties or cabling is impractical and unable to operate independent of manual tasks. Vacuum suction overcomes all of the other shortcomings and provides a reliable method to deliver the packages of many shapes and sizes.

These and other advantages of the present invention will be made apparent in view of the detailed description of the present invention along with the accompanying drawings listed below.

### BRIEF DESCRIPTION OF THE DRAWINGS

FIG. 1 is a schematic of the present invention.

### DETAILED DESCRIPTION OF THE PREFERRED EMBODIMENTS

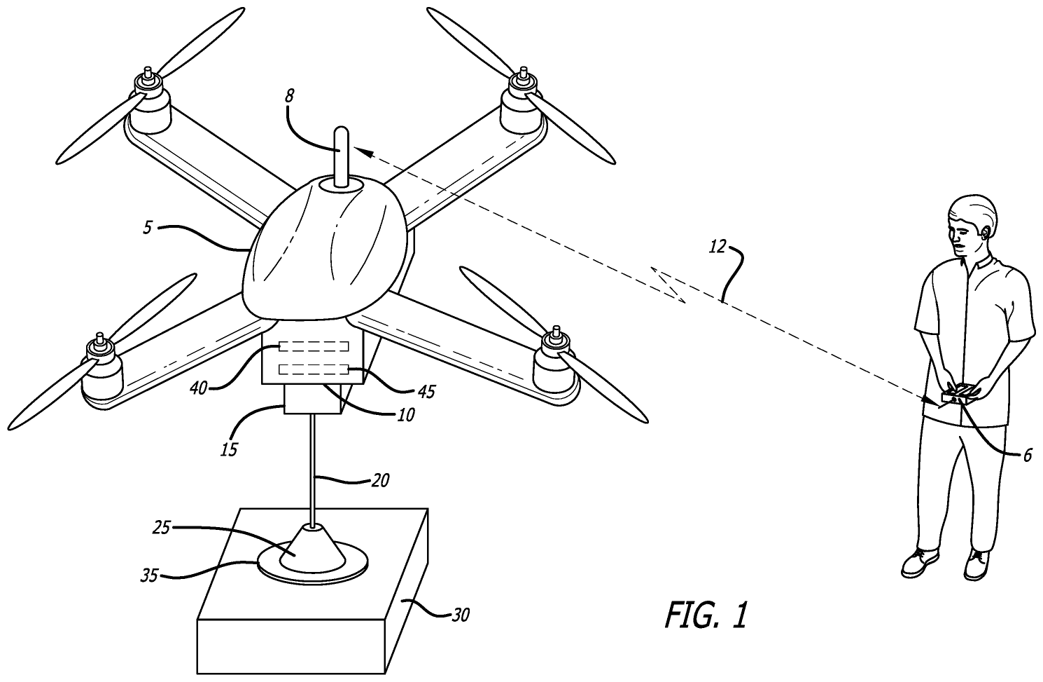

FIG. 1 shows a drone delivery system that includes an unmanned aerial vehicle 5 that is remote controlled and includes an antenna 8 of a control system 10 for receiving commands from a remote controller 6. The controller 6 sends wireless signals 12 to the aerial vehicle 5 to direct the aerial vehicle 5 to a location where an object 30 is to be delivered. The object 30 can be a hot meal, pharmaceuticals to an elderly patient, a birthday gift, or any object that falls within the loading limitations of the aerial vehicle. The aerial vehicle may be equipped with a GPS antenna for positioning the drone according to GPS signals received from GPS satellites.

The aerial vehicle 5 is further equipped with a vacuum pump 15 that may be connected to the power supply of the drone 5 or incorporate an independent power source, for generating a vacuum/valve that is used to attach and release the object 30. The vacuum pump 15 supplies a negative pressure (vacuum) along a tube 20 to a suction cup 25. The suction cup may attach directly to the object 30, or there may be a smooth, planar object such as a plate 35 that is attached to the object to provide a compatible surface for preserving pressure in the suction cup 25.

The vacuum pump 15 is electrically connect to the power source 40 with a relay switch 35 that may also be controlled by the remote control 6, a manual, optical or other such that the switch 35 is normally open but when the drone is started up the switch closes to power to vacuum pump 15. The activation of the vacuum pump 15 causes a vacuum to occur in the suction cup 25 via the hose 20 and releasably attach the object 30 to the aerial vehicle 5. Once the aerial vehicle is positioned over its destination, a user toggles the switch 45 using the remote 6, causing the vacuum pump/valve 15 to become disconnected from the power supply 40 and thus cause the pressure in the suction cup 25 to equalize with the ambient pressure. The weight of the object 30 overcomes the residual pressure and cause the object 30 to be released from the suction cup 25 so as to drop or be placed at the desired delivery location.

There are many types of drones that are suitable for this purpose, and the invention is not limited to any specific type of aerial vehicle. As long as the aerial vehicle can be operated remotely and can lift and carry the intended object while operating regularly, the aerial vehicle will meet the requirements of this invention. Moreover, other vacuum configurations can fill the role of the release mechanism other than those shown in the FIGURE and the attachment can be arranged in alternate manners using multiple connection points, multiple couplings, etc. Thus, the invention should not be construed as being limited to the described or depicted embodiments, but rather the invention's scope is governed by the appended claims using the ordinary meanings of the words used therein.

1. A device for delivering emergency or time sensitive packages to a destination, comprising:
an unmanned aerial vehicle controlled remotely by a control unit, the unmanned aerial vehicle comprising a power supply;
a relay switch connected to the power supply;
a vacuum pump connected to the power supply through the relay switch, the vacuum pump including a hose and a suction cup;
a vacuum valve connected to the power supply through the relay switch to release the vacuum upon command;
a remote control for operating the unmanned aerial vehicle and for activating and deactivating the relay switch; and
an object configured for delivery by the unmanned aerial vehicle, the object connected to the suction cup of the vacuum pump;
wherein the remote control unit disconnects the power to the vacuum pump and thereby releases the object at a remote location.

2. The delivery device of claim 1, wherein the object includes a substantially smooth plate or surface for adhering to the suction cup.
